(19) United States
(12) Patent Application Publication
(10) Pub. No.: US 2018/0130374 A1
(43) Pub. Date: May 10, 2018

(54) PARENT AND CHILD ATTACHABLE FOOTWEAR

(71) Applicant: Mark Patrick Hilley, Port Orange, FL (US)

(72) Inventor: Mark Patrick Hilley, Port Orange, FL (US)

(21) Appl. No.: 15/863,950

(22) Filed: Jan. 7, 2018

Related U.S. Application Data
(60) Provisional application No. 62/573,160, filed on Oct. 17, 2017.

(51) Int. Cl. G09B 19/00; A43B 3/30; A43B 13/14; A43B 23/02; A43B 1/00; A43B 3/10; A63B 69/00

(52) U.S. Cl. CPC G09B 19/0038; A43B 3/30; A43B 13/14; A43B 23/0245; A43B 1/0081; A63B 2209/10; A43B 3/102; G09B 19/003; A63B 69/00; A63B 2244/22; A43B 1/0054

(57) ABSTRACT

Footwear that connects a child's feet to an adult's feet for walk training or dance training of the child by the adult. The child's footwear has a first part of an attachment device such as hook-and-loop fastener material or a magnet on or in each sole. The adult footwear has a corresponding second part of the attachment device on or in the tops of the toe boxes. The adult can hold the child's hands to lift the child and place their feet on the adult's feet. This connects the soles of the child's footwear to the tops of the toe boxes of the adult footwear on contact in any of at least two orientations, including the child facing the adult for dancing, and the child facing away from the adult for walk training.

### CROSS-REFERENCE TO RELATED APPLICATIONS

This application claims the benefit of U.S. provisional patent application 62/573,160 filed Oct. 17, 2017.

### FIELD OF INVENTION

The present invention relates to child footwear that connects to corresponding adult footwear to facilitate training the child to walk or dance.

### BACKGROUND

An adult can train a child to walk or dance by placing the child's feet on the adult's feet. However, the child's feet can easily slip off the adult's feet during the steps. U.S. Pat. No. 2,761,223 shows means for attaching a child's shoe beside each adult shoe via horizontal pins through the adjoining soles, but this requires either taking off the shoes to connect them or the adult bending over and around the child to manipulate and insert the pins. It also could cause the adult to trip over the child's shoes, since they are affixed between the adult's feet. German patent DE10218800C1 shows a platform 3 attached to the instep side 7 of each adult shoe 2. A child's foot or shoe 4 can stand on the platform 3 within a retention border 6 of the platform. The platform can cause the adult to trip, being attached between the adult's feet. Neither of the above devices is suitable for teaching a child to dance, because the child is beneath the adult, between the adult's legs instead in front of the adult.

### SUMMARY OF THE INVENTION

To provide feet-on-feet training for a child to walk or dance, a quick attachment device is provided on the top of the toe boxes of the left and right shoe or slipper of an adult. A corresponding quick attachment device is provided on the soles of the left and right shoe or slipper of a child. A child wearing the footwear can step onto, or be lifted onto, an adult's feet with the footwear. This quickly attaches the child's feet to the adult's feet. The child can face the adult for dancing, or face away from the adult for walk training.

### DRAWINGS

The invention is explained in the following description in view of the drawings that show:

FIG. 1 is a side view of a child's shoe or slipper approaching an adult shoe or slipper for attachment thereto by hook-and-loop material such as Velcro®.

FIG. 2 is a side view of a child's slipper approaching an adult slipper for attachment thereto.

FIG. 3 is a side view of a child's shoe or slipper approaching an adult shoe or slipper for attachment thereto in a dance position.

FIG. 4 is a side view of a magnetic embodiment of a child's shoe or slipper approaching an adult shoe or slipper for attachment thereto.

### DETAILED DESCRIPTION

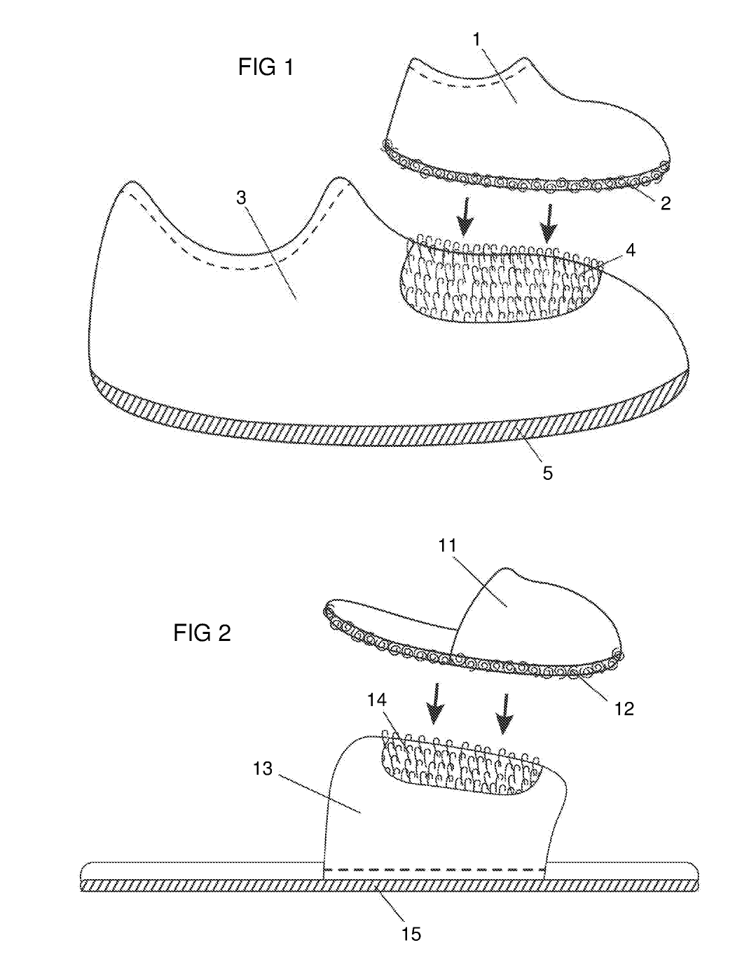

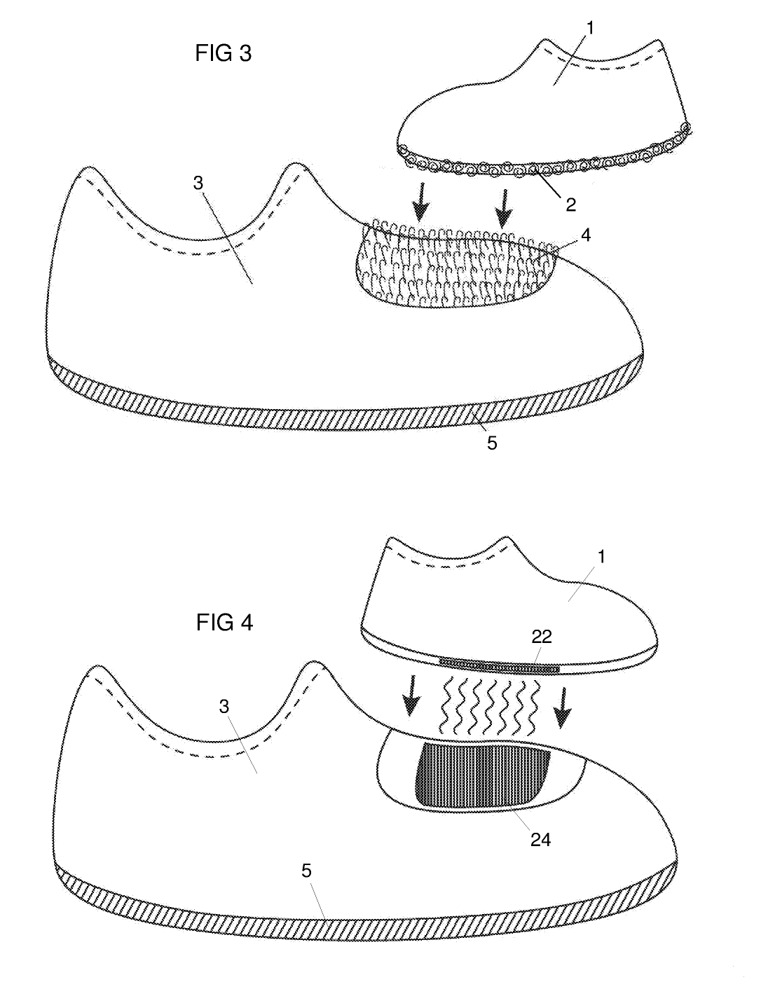

FIG. 1 shows a child's shoe or slipper 1 approaching an adult shoe or slipper 3 for attachment thereto via hook-and-loop material 2 on the sole of the child's shoe and corresponding material 4 on the top of the toe box of the adult shoe, which may have a conventional sole 5. When the adult holds the child's hands and places the child's feet on top of their own, the materials 2 and 4 engage, fastening each of the child's feet to the corresponding foot of the parent. The child may face the same direction as the adult as shown for walk training, or the child may face the adult for dance training as shown in FIG. 3.

Instead of hook-and-loop material, another quick fastening device may be used, such as a magnetic material on each shoe. Herein “magnetic material” means a magnet or a material attracted to a magnet. For example, a magnet may be sewn on or within the toe box of the adult shoe, and a corresponding magnetic material may form the outsole or a portion or layer in the sole of the child's shoe. The adult shoes and the child shoes may all have magnets, or both adult shoes may have a magnet and both child shoes may have a material that is attracted to a magnet, or both child shoes may have a magnet and both adult shoes may have a material that is attracted to a magnet.

In any embodiment, the fastening device should instantly attach the child's shoe to the adult shoe on contact, and instantly detach by pulling the child's shoe away from the adult shoe, all without handling of the fastener. It should allow the child to stand on the adult toe boxes and be fastened thereto in any orientation, or at least two orientations including facing away from the adult or toward the adult.

FIG. 2 shows a child's slipper 11 approaching an adult slipper 13 for attachment thereto via hook-and-loop material 12 on the sole of the child's slipper and corresponding material 14 on the top of the toe box of the adult slipper, which may have a conventional sole 15. When the adult holds the child's hands and places the child's feet on top of their own, the materials 12 and 14 engage, fastening each of the child's feet to the corresponding foot of the parent.

FIG. 3 shows the same elements of FIG. 1, with the child' shoe 1 facing opposite the adult shoe 3. The child can stand on the toe box of the adult shoe and be connected in a dance position. There is no tripping hazard as in the prior art, and the adult does not have to bend over and reach around the child or remove the shoes to manually connect and disconnect them.

To optimize a child's foot position in two different uses—walk training and dance training—the fastening device or material 2 on the child's footwear may extend over at least part of the front ⅓ of the soles of the child's footwear and over at least part of the back ⅓ of the soles of the child's footwear. The fastening material being on the front ⅓ of the child's footwear allows positioning of the child's footwear as shown in FIG. 3, connected to the adult footwear mainly or fully by the front part of the child's foot. This provides space between the child and the legs of the adult, and gives the child freedom to either stand flat-footed on the adult shoe or for the child to rise up on his/her toes. The fastening material 2 may completely cover the soles of the child's footwear as shown in FIG. 3, or it may have a gap in least part of the center ⅓ that is uncovered by the fastening material 2.

FIG. 4 shows a child's shoe or slipper 1 approaching an adult shoe or slipper 3 for attachment thereto magnet or magnetic material 22 on the sole of the child's shoe and a corresponding magnetic material or magnet 24 on the top of the toe box of the adult shoe, which may have a conventional sole 5. When the adult holds the child's hands and places the child's feet on top of their own, the magnets 22 and 24 engage, fastening each of the child's feet to the corresponding foot of the parent.

While various embodiments of the present invention are shown and described herein, such embodiments are provided by way of example only. Variations, changes and substitutions may be made without departing from the invention herein. It is intended that the invention be limited only by the scope of the claims

1. Footwear that connects a child's feet to an adult's feet for walk training or dance training of the child by the adult, comprising:
a child footwear comprising a first part of an attachment device on or in each sole thereof; and
an adult footwear comprising a corresponding second part of the attachment device on or in the top of each toe box thereof;
wherein when the feet of a child wearing the child footwear are placed on the feet of an adult wearing the adult footwear, the soles of the child footwear attach on contact to the tops of the toe boxes of the adult footwear in any of at least two orientations, including the child facing the adult for dancing, and the child facing away from the adult for walk training.

2. Footwear that connects a child's feet to an adult's feet for walk training or dance training of the child by the adult, comprising;
a child footwear comprising a first part of an attachment device on or in each sole thereof; and
an adult footwear comprising a second part of the attachment device on the top of each toe box thereof;
wherein the first and second parts of the attachment device connect to each other on contact, and the first and second parts release from each other by pulling them apart; and
wherein when a child wears the child footwear and an adult wears the adult footwear, the soles of the child footwear connect to the tops of the toe boxes of the adult footwear in any of at least two orientations comprising the child facing the adult for dancing, and the child facing away from the adult for walk training.

3. The footwear of claim 2 wherein the first and second parts of the attachment device connect to each other on contact instantly and without direct hand manipulation of the first and second parts.

4. The footwear of claim 2 wherein the first and second parts of the attachment device comprise respective first and second parts of a hook-and-loop fastener material.

5. The footwear of claim 2 wherein the first part of the attachment device comprises a magnet or a material attracted to a magnet, and the second part of the attachment device comprises respectively a material attracted to a magnet or a magnet.

6. Footwear that attaches the feet of a first person to the feet of a second person for walk training or dance training of the first person by the second person, comprising;
a first pair of shoes or slippers comprising a first part of an attachment device on or in each sole thereof;
a second pair of shoes or slippers comprising a second part of the attachment device on or in the top of each toe box thereof;
wherein the first and second parts of the attachment device connect to each other on contact without direct handling of the first and second parts, and the first and second parts release from each other by pulling them apart; and
wherein when a person wearing the first pair of shoes stands on the toe boxes of a second person wearing the second pair of shoes, the feet of the first person move with the feet of the second person.

7. The footwear of claim 6 wherein the first and second parts of the attachment device connect to each other on contact in any orientation.

8. The footwear of claim 6 wherein the first and second parts of the attachment device connect to each other instantly on contact in at least two orientations including wherein the first pair of shoes face the same direction as the second pair of shoes and wherein the first pair of shoes face the opposite direction from the second pair of shoes.

9. The footwear of claim 6 wherein the first and second parts of the attachment device comprise respective first and second parts of a hook-and-loop fastener material.

10. The footwear of claim 6 wherein the first part of the attachment device comprises a magnet or a material attracted to a magnet, and the second part of the attachment device comprises respectively a material attracted to a magnet or a magnet.

11. The footwear of claim 6, wherein the first part of the attachment device covers at least part of a front ⅓ of each sole of the child footwear and at least part of a back ⅓ of each sole of the child footwear.

12. The footwear of claim 11, further comprising a gap in the first part of the attachment device in at least part of a middle ⅓ of the sole of the child footwear.
